(19) United States
(12) Patent Application Publication
(10) Pub. No.: US 2008/0035707 A1
(43) Pub. Date: Feb. 14, 2008

(54) TRANSIENT-LIQUID-PHASE JOINING OF CERAMICS AT LOW TEMPERATURES

(75) Inventor: Andreas M. Glaeser, Berkeley, CA (US)

Correspondence Address: LAWRENCE BERKELEY NATIONAL LABORATORY, ONE CYCLOTRON ROAD, MAIL STOP 90B, UNIVERSITY OF CALIFORNIA, BERKELEY, CA, 94720, US

(73) Assignee: THE REGENTS OF THE UNIVERSITY OF CALIFORNIA, Oakland, CA (US)

(21) Appl. No.: 11/837,489

(22) Filed: Aug. 10, 2007

Related U.S. Application Data
(60) Provisional application No. 60/822,303, filed on Aug. 14, 2006.

(51) Int. Cl. B23K 28/00; B23K 31/02

(52) U.S. Cl. 228/121; 228/194

(57) ABSTRACT

A novel method for bonding components has been disclosed. For bonding ceramic components the method involves placing at least three metal interlayers between the components. There is a central core metal layer and two other metal layers placed on either side of the core layer adjacent the ceramic components. The metal layers are heated to a temperature sufficient to transform at least part of the metal layers into a liquid. The temperature is maintained until the liquid begins to solidify and the first points of bonding between the components and the solidifying interlayer is established. This system can also be used to bond a ceramic component to a metal component. The metal component can be placed adjacent the central core metal layer without an intervening metal layer.

### STATEMENT OF GOVERNMENTAL SUPPORT

The invention described and claimed herein was made in part utilizing funds supplied by the U.S. Department of Energy under Contract No. DE-AC03-76SF00098, and more recently under DE-AC02-05CH11231. The government has certain rights in this invention.

### BACKGROUND OF THE INVENTION

1. Field of the Invention

This invention relates generally to joining of materials, and, more specifically, to methods of using brazing foils at unusually low temperatures to form strong bonds between ceramic pieces.

2. Background

Joining is a critical enabling technology, essential to widespread use of ceramics in many applications. Specifically, it allows the fabrication of large, complex, multimaterial, multifunctional assemblies through the controlled integration of smaller, less complex, more easily manufactured parts. Additionally, it can provide an avenue for repair of damaged structures through the replacement of defective components. This can extend the lifetimes of assemblies, and permit the reuse of components that are not readily recycled, e.g., fiber-reinforced materials.

Material degradation during joining and interfacial reactions that produce undesirable and structurally defective reaction layers can limit the properties and reliability of joined assemblies. The extent of degradation or reaction often increases with increasing joining temperature. Thus, when materials that are nanostructured and prone to coarsening, are amorphous and may crystallize, or otherwise have temperature-sensitive properties are part of a joined assembly, it becomes increasingly important to reduce the joining temperature below some critical threshold temperature to mitigate such problems. Concurrently, it may be necessary to maintain the potential for service at temperatures that approach this critical threshold temperature.

Thus it is important to develop joining methods that yield reliably strong interfaces at “low” joining temperatures, but that preserve the potential for use at temperatures that equal or exceed the joining temperature. An illustrative example of an assembly that exploits a multilayer interlayer design to achieve these objectives is shown in FIG. 1. The cladding layers are designed to form thin liquid layers at “low” temperatures. The core layer remains solid during joining. In transient-liquid-phase (TLP) joining, the overall composition of the interlayer lies in a solid solution phase field. Thus, the liquid is not stable and disappears due to interdiffusion. While the (transient) liquid is present, it fills interfacial gaps and facilitates joint formation. The remelt temperature of the homogenized interlayer exceeds the original joining temperature.

One class of joining processes, exemplified by diffusion bonding, involves purely solid-state processing. The components to be joined can be brought into direct contact or, as is often the case for ceramic-ceramic joining, a metallic foil can be inserted between the ceramic components. Application of a pressure at elevated temperature promotes the formation of a bonded interface between the materials to be joined. The temperatures required for joining are often a high fraction of the melting temperature of the least refractory component due to the need to activate solid-state diffusion. Component deformation and microstructural changes such as grain growth or precipitate coarsening within the components can degrade properties.

A broader range of processes involves melting either the material(s) to be joined, or some other material introduced into the joint region. Examples include soldering, brazing, and welding. Solders, by definition, melt at <840° F. (≦450° C.). As a result, the joints have limited service temperature capability, and can be mechanically inferior to the bulk materials that have been joined. Brazes require higher processing temperatures (>840° F.). The higher melting temperatures of brazes can lead to higher service temperatures; however, the higher processing temperatures can overlap with the aging temperatures of some metallic alloys, resulting in a loss of peak hardness. Other forms of microstructural degradation are also possible. Welding involves localized heating, melting, and subsequent solidification. A major concern in welding of metals is the development of a heat-affected zone. Although metal-metal welding is common, and ceramic-ceramic welding has been explored, examples of ceramic-metal bonding via welding are sparse.

TLP joining has been applied to a range of structural metals, notably nickel-base superalloys, and more recently the method has been extended to intermetallics. When applied to metal-metal joining, an interlayer containing a melting point depressant (MPD) is placed between the two objects to be joined. Boron serves as an effective MPD for nickel, and is thus a common interlayer component when nickel-base superalloys are joined. At the joining temperature, rapid (interstitial) diffusion of boron into the adjoining (boron-free) nickel-base superalloys leads to a progressive decrease in the amount of liquid. Ultimately, the liquid disappears. Counter-diffusion of alloying elements in the nickel-base superalloys into the interlayer region leads to joint chemistries and properties that approach those of the base material, and such joints are compatible with use in structural applications at elevated temperature.

When the method is extended to facilitate ceramic joining by metallic interlayers, the disappearance of the liquid generally requires diffusion of a low-melting-point metal that acts as an MPD into an adjoining solid phase. For some systems, incorporation of the MPD into the ceramic is slow in comparison to diffusion into the solid core layer of the multilayer interlayer, and hence this latter diffusion path controls the rate of liquid disappearance. Schematic figures of interlayer configurations before bonding and after TLP bonding are shown in FIG. 2.

In formation of successful joints by this approach, the liquid flows along the interface to fill gaps and where there is sufficient liquid available gaps are filled completely. Gaps along the interface are likely to arise due to roughness and waviness of the substrate surfaces, local depressions or asperities on the surfaces, and incomplete coating of the substrate (or core layer) with the MPD-containing layer. In conventional brazing and soldering, if two ceramic components are to be joined, then it is the contact angle of the liquid braze or solder on the ceramic that will determine whether the liquid will recede from (enlarge) or advance into (fill) an interfacial gap. In the case of multilayer metallic interlayers, the liquid film is sandwiched between two dissimilar materials, the metal core and the ceramic. Thus, two contact angles, and more specifically their sum, will dictate the (short-time) response of the liquid. The surface topography will modify the energetic considerations, and also impact the liquid film thickness required to fill interfacial voids.

In FIG. 3, a film is shown between two dissimilar but parallel substrates. The contact angle on the core layer, θ₁, is shown to be acute, as would normally be the case for a metal on a metal, while the contact angle on the ceramic, θ₂, is shown as obtuse, as would normally be the case for nonreactive metals on ceramics. The liquid film will fill voids if θ₁+θ₂<180°. If a typical liquid metal (with θ>90°) were sandwiched between two ceramic substrates, the liquid would “dewet” the interface, introduce significant porosity, and lead to nonhermetic low-strength joints. Thus, one of the advantages of a multilayer interlayer approach is that a high θ₂ is permissible, if θ₁ is sufficiently low. When θ₁+θ₂<180°, it implies that, γ_{Core/Liq}+γ_{Liq/Ceramic}<γ_{Core/Vapor}+γ_{Ceramic/Vapor} where γ_{i/j} is the specific surface or interfacial energy of the i/j interface.

When the bonding surfaces are rough, a more stringent condition emerges. If the contact angles of liquid on the core layer and the ceramic are again denoted θ₁ and θ₂, respectively, but local depressions on the opposing core layer and ceramic surfaces cause angular deviations of α₁ and α₂, respectively, from a parallel surface geometry, then flow of liquid into voids will only occur if the condition (θ₁+α₁)+(θ₂+α₂)<180° is met. Since θ₁ and θ₂ can vary as the surface orientations and surface energies of the metal and ceramic grains vary, and α₁ and α₂ will vary with location along the interface, the potential exists for regions of the interface with diverging surfaces (α₁+α₂>0) to have unfavorable wetting conditions. A rougher surface with locally larger values of α₁ and α₂ would be more likely to contain voids that persist or develop due to liquid film redistribution. In addition, spatial variations in (θ₁+α₁)+(θ₂+α₂) could establish conditions that redistribute the liquid from filled regions where the sum is higher into unfilled regions where the sum is lower, thereby generating interfacial flaws.

When properly implemented, TLP joining methods are capable of producing joined assemblies with reproducible and robust joint properties. When incomplete wetting occurs, regions of the interface remain or become liquid-free, and a triple-junction ridge develops where the liquid metal, ceramic, and vapor phases form mutual contact. Fractography indicates that these regions are more prevalent in samples with lower fracture strength. The wetting characteristics of the liquid film can be improved by precoating the ceramic surface with a metal, or by altering the liquid film chemistry. The liquid film chemistry can be adjusted by adding directly to the cladding layer a second component that improves wetting. Alternatively, since some dissolution of the core layer is inevitable, the addition of elements that enhance the wetting can be achieved by their incorporation in the core layer. In some of the systems examined, the implementation of such approaches has yielded assemblies in which fracture occurs primarily within the ceramic, indicating that the ceramic-metal interface has higher strength than the ceramic.

Many multilayer interlayer systems have been developed and used to join alumina and silicon-based ceramics. In general, the most common low-melting-point component of the interlayer has been copper, and core layers with melting points several hundred degrees higher have been used. Examples of multilayer interlayers used to join alumina include: Cu/Pt/Cu, Cu/Ni/Cu, Cr/Cu/Ni/Cu/Cr, and Cu/80Ni20Cr/Cu. Similar strategies have been employed in bonding silicon-based ceramics. Interlayers of Au/80Ni20Cr/Au have also been explored for TLP bonding of silicon nitride. Silicon nitride and silicon carbide have also been joined using a Cu—Au/Ni/Cu—Au-based interlayer designed to form a liquid phase at <950° C. Changes in processing conditions, specifically the processing temperature, were found to have a strong effect on silicon nitride joint properties. A plot summarizing strength distributions for various interlayer and ceramic combinations is provided in FIG. 4. Reliably strong joints can be produced with interlayer chemistries compatible with higher service temperatures than those typical of many commercial reactive-metal brazes.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 is a schematic illustration of an assembly with a multilayer interlayer. Two relatively thin cladding layers that form a liquid at low temperature flank a thicker, higher melting point core layer that dominates the composition and ultimate physical properties of the interlayer.

FIG. 2 is a schematic drawing of interlayer configurations a) before bonding, b) after TLP bonding showing partial chemical homogenization.

FIG. 3 is a schematic illustration of a thin liquid film sandwiched between a solid metallic core layer and a ceramic on which the liquid has contact angles θ₁ and θ₂, respectively. For parallel core layer and ceramic surfaces, void filling requires that θ₁+θ₂<180°. At later stages, liquid-film-assisted growth of ceramic-core contact produces a “dewetting” of the ceramic-core layer interface and results in isolated droplets of liquid.

FIG. 4 shows room-temperature strength distributions for different interlayer designs used to join alumina and silicon nitride. Cu/Pt, Cu/Ni, and Cu/80Ni20Cr interlayers were used to bond alumina. Note the beneficial effect of Cr additions. The Cu—Au—Ti/Ni interlayer was used to bond silicon nitride; the two lines correspond to different joining temperatures.

FIG. 5 shows failure probability-fracture strength behavior of TLP bonds made at a) “lower” and b) “higher” temperatures. Strengths approaching those of the ceramic can be achieved.

FIGS. 6a and 6c are SEM images of an In/Cusil-ABA™/In interlayer after 1.5 h bonding time at 700° C. FIG. 6b is an EDS (energy-dispersive spectroscopy) scan along the line indicated in FIG. 6a.

FIG. 7 shows plots of fracture probability vs. fracture strength for alumina joined using In/Silver ABA™/In interlayers. (a) 20 min bonding cycle at 800° C., and comparison to conventional reactive-metal brazing. (b) Effect of bonding time and temperature on strength and failure characteristics of TLP bonds.

FIG. 8 shows a plot of fracture probability vs. fracture strength for alumina joined using In/Cusil/In interlayers and In/Ticusil-ABA™/In interlayers. The bonds were formed at 700° C. for ˜1.5 hours. the results from bonds made at 700° C.

FIG. 9a shows an “exploded” view of the material arrangements and FIG. 9b shows a view of the materials when they are in contact with one another, as used in a method of joining components, according to an exemplary embodiment of the invention.

FIG. 10a shows an “exploded” view of the material arrangements and FIG. 10b shows a view of the materials when they are in contact with one another, as used in a method of joining components, according to another exemplary embodiment of the invention.

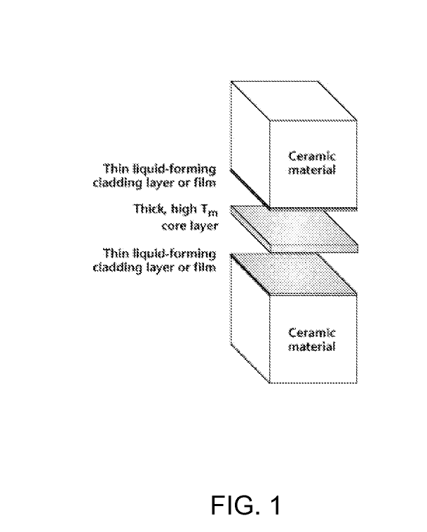

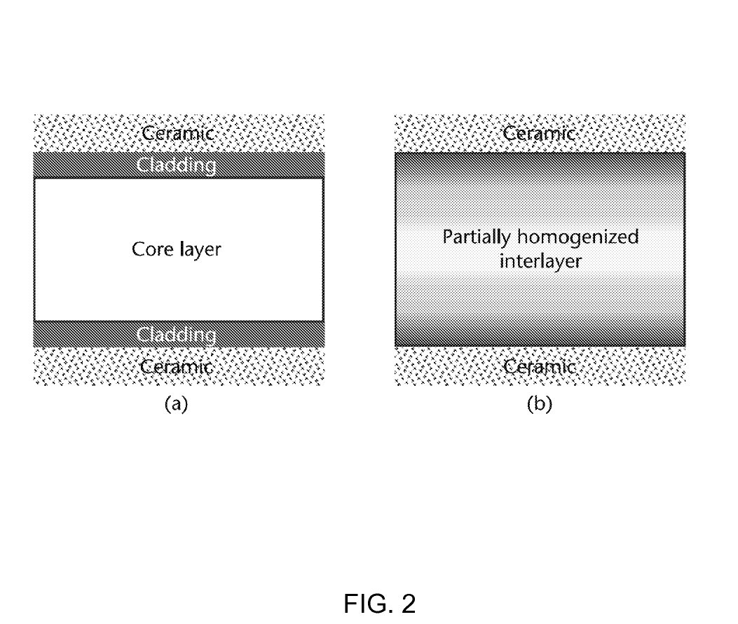

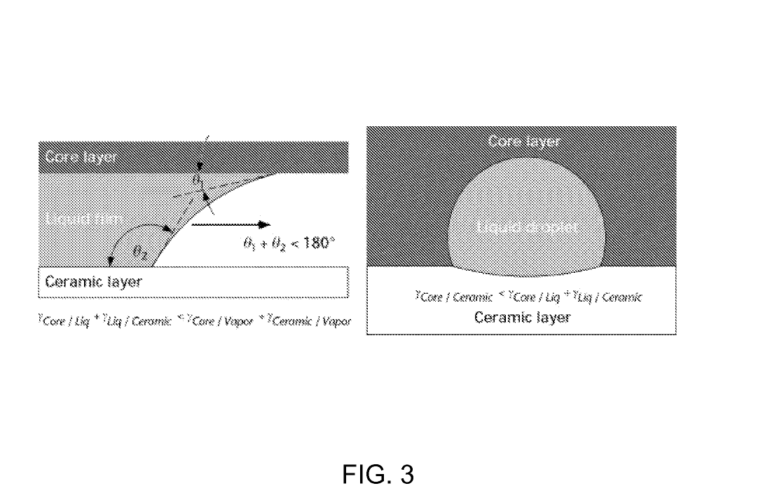

### DETAILED DESCRIPTION

The term “metal” is used herein to mean elemental metals or combinations of metals such as alloys or intermetallic compounds.

An interest in extending the TLP approach to lower temperatures inspired efforts to utilize commercially available, widely used, reactive-metal brazes in conjunction with cladding layers having melting temperatures less than 450° C., which are characteristic of solders.

Commercially available 99.5% pure (AD995, Coors Technical Ceramic Co., Oak Ridge, Tenn.) or 99.9% pure (SSA-999W, Nikkato Corp., Osaka, Japan) aluminum oxide in the form of 19.5 mm×19.5 mm×22.5 mm blocks was used for assemblies intended for mechanical testing. The finer grain size 99.9% alumina has a higher fracture strength, but its properties can be affected by the thermal cycle during joining. The joining surfaces of the blocks were ground flat on a surface grinder using a 400-grit diamond wheel. Joints processed with unpolished alumina substrates were then cleaned while those processed with polished alumina substrates were polished with progressively finer grit size diamond suspensions (South Bay Technologies, San Clemente, Calif.) before cleaning. After polishing with a 1-μm diamond suspension, either a final chemical-mechanical polish was performed using colloidal silica (Struers, Westlake, Ohio), or a final mechanical polish using 0.25-μm grit diamond paste was performed. Samples to investigate interfacial microstructure evolution were fabricated using ≈0.5-mm-thick, high-purity, optical finish, c-axis or m-axis sapphire substrates (Crystal Systems Inc., Salem, Mass.) that required no additional polishing.

Polished, 20 mm×20 mm×20 mm blocks of a 99.9% pure (SSA-999W, Nikkato Corp., Osaka, Japan) Al₂O₃ were joined using Ag-based, Cu-based or Cu—Ag eutectic based brazing foils with Ti additions as core layers, and In, which melts at 156.6° C., as cladding layers. Ag-ABA™ (97.75% Ag, 1% Al, 1.25% Ti; 75-μm thick), Cusil-ABA™ (63% Ag, 35.25% Cu, 1.75% Ti; 50-μm thick), and Ticusil-ABA™ (68.8% Ag, 26.7% Cu, 4.5% Ti; 50-μm thick) core layers with 2-μm thick In cladding layers were used for TLP joining. Incusil-ABA™ foils (59% Ag, 27.25% Cu, 12.5% In, 1.25% Ti; 50-μm thick) were used in reference joining by brazing. All compositions are in wt. %. The solidus and liquidus temperature pairs are 860° C. and 912° C. for Ag-ABA™, 780° C. and 815° C. for Cusil-ABA™, 780° C. and 900° C. for Ticusil-ABA™and 605° C. and 715° C. for Incusil-ABA™. Indium additions reduce the processing temperature but also the temperature capabilities of joined assemblies relative to Cusil-ABA™.

Properties of commercially-available ABA™ brazes are summarized in Table I.

TABLE I

| | Composition in wt % | | | | | Liquidus | Solidus |
|---|---|---|---|---|---|---|---|
| Trade Name | Ag | Au | Cu | Si | Other | ° C. | ° C. |
| Incusil-ABA ™ | 59 | | 27.25 | | 12.5 In | 715 | 605 |
| | | | | | 1.25 Ti | | |
| Cusil-ABA ™ | 63 | | 35.25 | | 1.75 Ti | 815 | 780 |
| Ticusil-ABA ™ | 68.8 | | 26.7 | | 4.5 Ti | 900 | 780 |
| Silver-ABA ™ | 92.75 | | | | 1 Al | 912 | 860 |
| | | | | | 1.25 Ti | | |
| Copper-ABA ™ | | | 92.75 | 3 | 2 Al | 1024 | 958 |
| | | | | | 2.25 Ti | | |

For brazing and TLP joining, 75-μm-thick, 99.95% pure silver foils (Alfa Aesar, Ward Hill, Mass.), silver-based reactive-metal braze foils, Silver ABA™ (Morgan Advanced Ceramics, Belmont, Calif.), and a Cu—Ag—Ti-based reactive metal foil, Ticusil-ABA™ (Morgan Advanced Ceramics, Belmont, Calif.) were used. In the TLP bonding experiments, a >99.998% pure indium source (Alfa Aesar, Ward Hill, Mass.) was used to develop cladding layers. The indium and silver were deposited directly onto the alumina surfaces by melting the source material and allowing it to evaporate in a high-vacuum chamber containing the ceramic blocks. Film thicknesses were measured using profilometry (Tencor Instruments Inc., San Jose, Calif.) and weight-gain measurements. The combined thickness of the indium film and a very thin capping layer of 99.9% pure silver (designed to prevent indium oxidation) was ≈2.2 μm. For Silver ABA™ core layers, the multilayer interlayer has an overall composition (in wt %) of 89.1% Ag, 4.8% Cu, 3.9% In, 1.2% Ti, and 1.0% Al.

All bonding was performed in a vacuum hot press. Brazing with pure silver and with Silver ABA™ was performed at 1000 and 960° C. for 10 min, respectively; silver melts at 960° C., while the liquidus temperature of Silver ABA™ is 912° C. TLP bonding with an indium cladding was performed at 700 and 800° C., below the Silver ABA™ solidus temperature of 860° C. with holding times varying from as little as 20 min up to 24 h. Typical heating rates and cooling rates were 10° C./min and 8° C./min, respectively, with a typical vacuum of <10⁻⁷ atm and an applied load of ≈4.6 MPa.

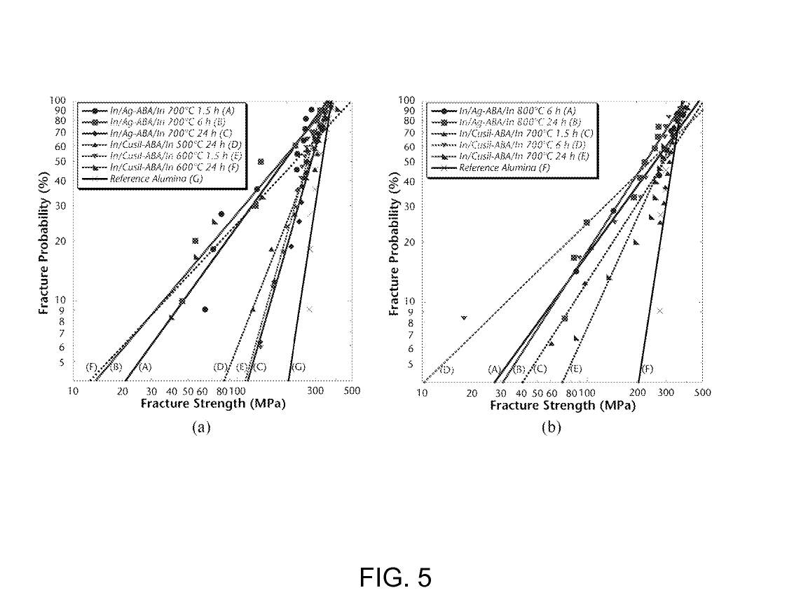

Bonds made using Cusil-ABA™ were processed at 500° C. for 24 h, at 600° C. for 1.5 h and 24 h, and 700° C. for 1.5 h, 6 h, and 24 h. Samples bonded with Ag-ABA™ were processed at 700° C. for 1.5 h, 6 h, and 24 h, and at 800° C. for 6 h and 24 h. An applied pressure of 4.6 MPa was used for all bonds. Samples for mechanical testing were prepared by first sectioning the bonded blocks into plates, and then subsequently into beams 3 mm×3 mm in cross section and 4 cm in length with the metal interlayer at the beam center. These beams were subjected to room-temperature four-point bend tests. Since the solidus and liquidus temperatures of Ag-ABA™ are higher than those of Cusil ABA™, the bonds made with Cusil-ABA™ at 500° C. and 600° C. and with Ag-ABA™ at 700° C. are compared in FIG. 5a, while those made at the higher temperatures are compared in FIG. 5b. Following trends in prior studies, joint strengths approaching those of the bulk reference ceramic were obtained, and some test specimens failed in the ceramic rather than in the joint region. For all bonding conditions, the average strength exceeded 200 MPa. However, as also seen previously, there is a significant scatter in strength, with failures along the interlayer-ceramic interface often occurring at low stress. Interlayer design modifications (e.g., involving increased Ti levels in the core or cladding) that reduce the contact angle(s) of the liquid may be useful.

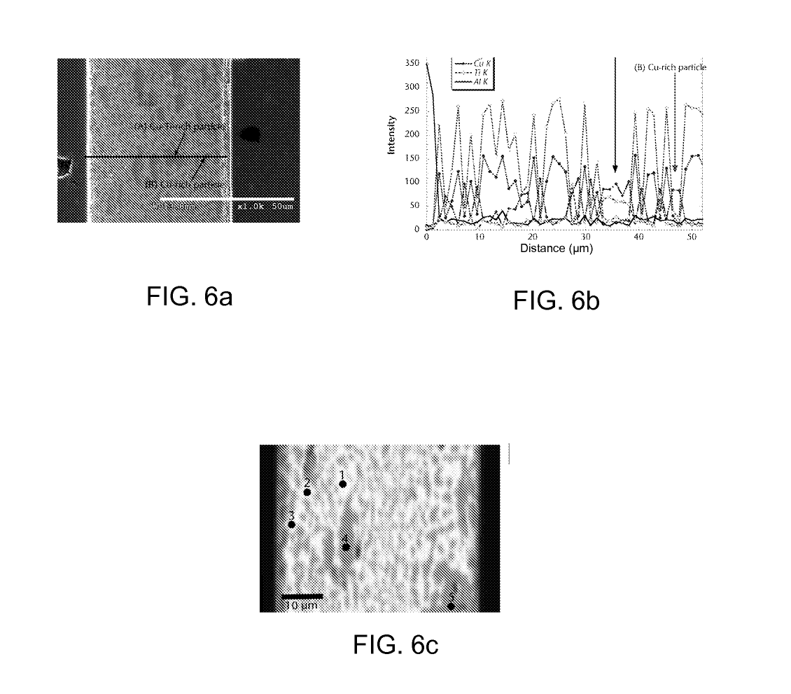

Microstructural and microchemical characteristics of an In/Cusil-ABA™/In interlayer are shown in FIG. 6. FIGS. 6a and 6c are SEM images of an In/Cusil-ABA™/In interlayer after 1.5 hours bonding time at 700° C. FIG. 6b is an EDS (energy-dispersive spectroscopy) scan along the line indicated in FIG. 6a. Table II shows electron probe microanalysis (EPMA) concentrations of Ag, Cu, In, and Ti in wt % at the locations indicated in FIG. 6c. Both EDS and EPMA analyses show the compositional variations expected in a multiphase microstructure. EPMA reveals that In is uniformly distributed throughout the Ag-rich matrix after 1.5 h at 700° C., indicative of liquid disappearance and full homogenization. Shorter bonding times are possible. Cu-rich particles were too small for reliable In analysis; the larger residual Cu—Ti-rich particles contain virtually no In. Neither EDS nor EPMA were able to confirm a Ti-containing reaction layer near the metal-ceramic interfaces. In contrast to the situation in brazing, where all the Ti in the interlayer is available to react at the braze-ceramic interface, in the present case only a fraction of the Ti is incorporated into the In-based liquid film. It may be that the amount of Ti dissolved during partial dissolution of the core layer is insufficient to produce wetting behavior comparable to that of commercially available reactive-metal brazes. In addition, the braze foil microstructure shows that the Ti is localized in Cu-rich particles within the interlayer (see analysis of points 4 and 5 in Table 1). Where near-surface particles containing Ti are dissolved, localized removal of Ti by reaction at the braze-ceramic interface may compete with diffusional redistribution of Ti parallel to the liquid film-ceramic interface over interparticle separation distances of perhaps tens of microns.

TABLE II

| Location | Ag | In | Cu | Ti |
|---|---|---|---|---|
| 1 | 90.072 | 7.229 | 4.516 | 0.016 |
| 2 | 89.325 | 7.199 | 3.970 | 0.120 |
| 3 | 86.480 | 7.067 | 6.465 | 0.100 |
| 4 | 2.685 | 0.134 | 77.827 | 15.579 |
| 5 | 1.563 | 0.138 | 79.357 | 16.170 |

Silver dissolves a significant amount of indium over a wide range of temperature. It was thus of interest to assess whether silver-rich interlayers could be produced in situ and used to bond alumina when indium serves as the low-melting-point cladding layer. Brazing experiments using pure silver foils, and TLP experiments with pure silver core layers and indium cladding layers were performed. Neither interlayer produced useful joints. Silver forms an obtuse contact angle on alumina and was therefore expected to dewet the interface. Indium reportedly forms a high contact angle on alumina, and thus, it was expected that the silver-indium combination would also be problematic. In practice, assemblies were not sufficiently robust to survive machining into plates and beams.

It had been anticipated that the wetting of the liquid film on alumina would need improvement. In prior work by Nakashima and co-workers and alumina joints prepared with Cu/Ni/Cu interlayers failed exclusively along the alumina-interlayer interface, and the joint strengths varied considerably. Examination of fracture surfaces indicated that large unbonded regions persisted along the alumina-interlayer interface. The results suggested that these flaws were involved in failure initiation, and that the statistical variations in these flaw sizes contributed to the wide strength distribution. Chromium additions were shown to reduce the contact angle of molten copper on alumina. By replacing a pure nickel core layer with an 80Ni20Cr core layer, dissolution of the core layer during joining added chromium to the liquid film. The significant improvement in joint characteristics achieved with a 80Ni20Cr core layer encouraged a parallel approach for silver-indium interlayers.

Key to success in using copper-silver eutectic brazes with reactive-metal additions (i.e., Cusil ABA™) to join alumina successfully is the addition of titanium, which promotes wetting of an otherwise nonwetting eutectic liquid. The copper-silver eutectic temperature is 780° C. Incusil ABA™ is an interesting derivative of these brazes. Incusil ABA™ contains 12.5% indium, which lowers the liquidus temperature to 715° C., and 1.25% titanium, which promotes wetting. Incusil ABA™ has also been used to join alumina successfully. This suggests that the copper-rich and silver-rich phases in this alloy, which contain indium and titanium, form strong interfaces with alumina.

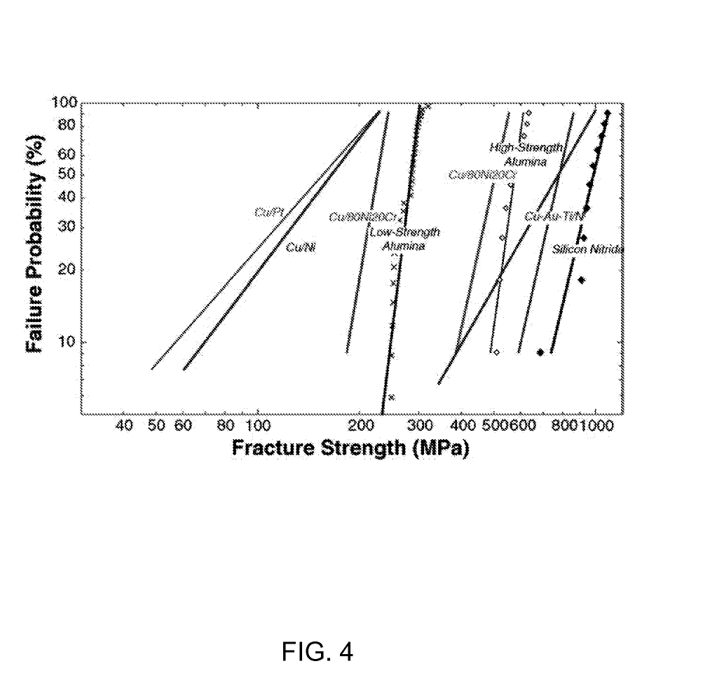

Joining experiments using thin indium cladding layers with Silver ABA™ have produced successful joints, and results are summarized in FIG. 4. To provide a basis for comparison, samples were brazed using Silver ABA™ and Incusil ABA™. For Silver ABA™, the average four-point bend strength was 330 MPa, with a standard deviation of 60 MPa; for Incusil ABA™, the corresponding values were 260 and 35 MPa. The as-received alumina had an average fracture strength of 320 MPa with a standard deviation of 30 MPa. Although most brazed samples failed in the ceramic, some samples failed along the alumina-interlayer interface, while others showed mixed ceramic and interfacial fracture paths. In samples brazed using In/Silver ABA™/In interlayers, at elevated bonding temperatures, indium melts and incorporates both silver and titanium from the Silver ABA™ core layer. Since the liquid film is silver-rich, it is substantially thicker than the original indium cladding layer. For bonds formed at 800° C., with hold times of 20 min, the average fracture strength for samples that failed in the ceramic (270±35 MPa) was comparable to those of samples brazed with Incusil ABA™. However, low-stress interfacial failures were also observed. An examination of fracture surfaces of the weak beams suggested incomplete contact between the interlayer and the ceramic.

Varying the bonding time (1.5, 6, and 24 hours) and temperature influenced the strength distributions. For samples bonded at 700° C., maximum average strength and minimum standard deviation was attained after a 24-hour hold. For samples bonded at 800° C., good results were obtained after a 1.5-h hold. In contrast to brazing, where all the titanium in the interlayer is available to form reaction layers, in TLP bonding, the total amount of titanium in each liquid film is smaller. It is possible that solid-state diffusion of titanium to the interface plays a role in the variations in strength. However, considering that the core layer compositions are optimized for brazing rather than TLP bonding, the results are very new and unexpected.

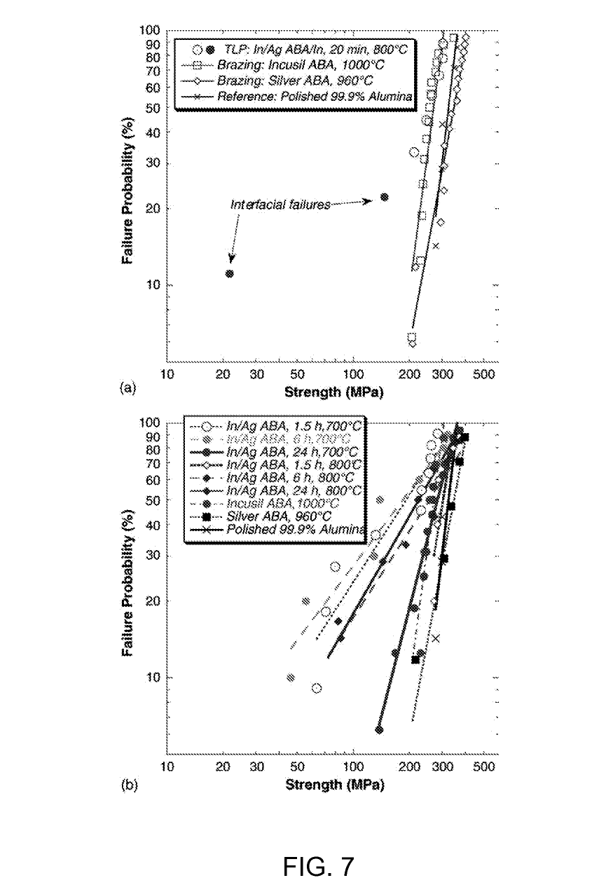

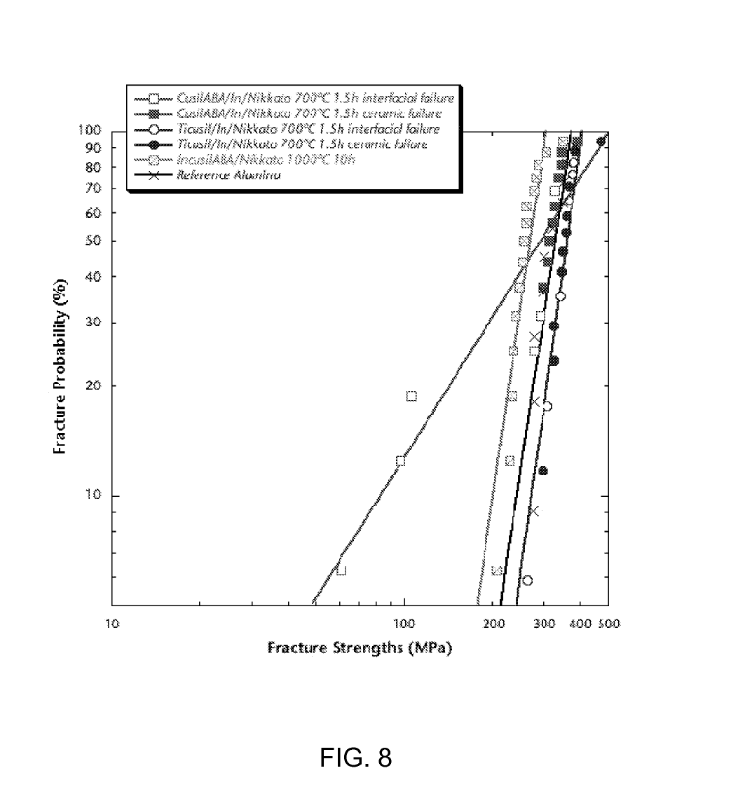

Joining experiments using thin indium cladding layers with Silver ABA have produced successful joints, and results are summarized in FIG. 7, which shows plots of fracture probability vs. fracture strength for alumina joined using In/Silver ABA/In interlayers.

TLP bonding provides an opportunity to join materials at reduced temperatures, which can be essential to preserving the performance of materials with temperature-sensitive microstructures. The results shown suggest that commercially available reactive-metal brazes coupled with low-melting-point cladding layers could be used to form joints at temperatures that are more commonly associated with soldering.

The methods and structures disclosed herein extend the temperature range of use for commercially available reactive metal brazes used to produce ceramic metal joints. Embodiments involving various interlayer designs and their appropriate time-temperature-pressure conditions for bonding have been discussed. Surprisingly, joining temperatures below minimum temperatures generally used for reactive metal brazes have been very successful in making excellent joints. The joints thus produced are very strong and the benefit of protecting temperature-sensitive components and materials is achieved. Thin, low melting point films, e.g., In, form thin liquid films that facilitate ceramic-metal joining and then disappear by interdiffusion. This provides a mechanically robust joint capable of high temperature service without even higher temperature joining.

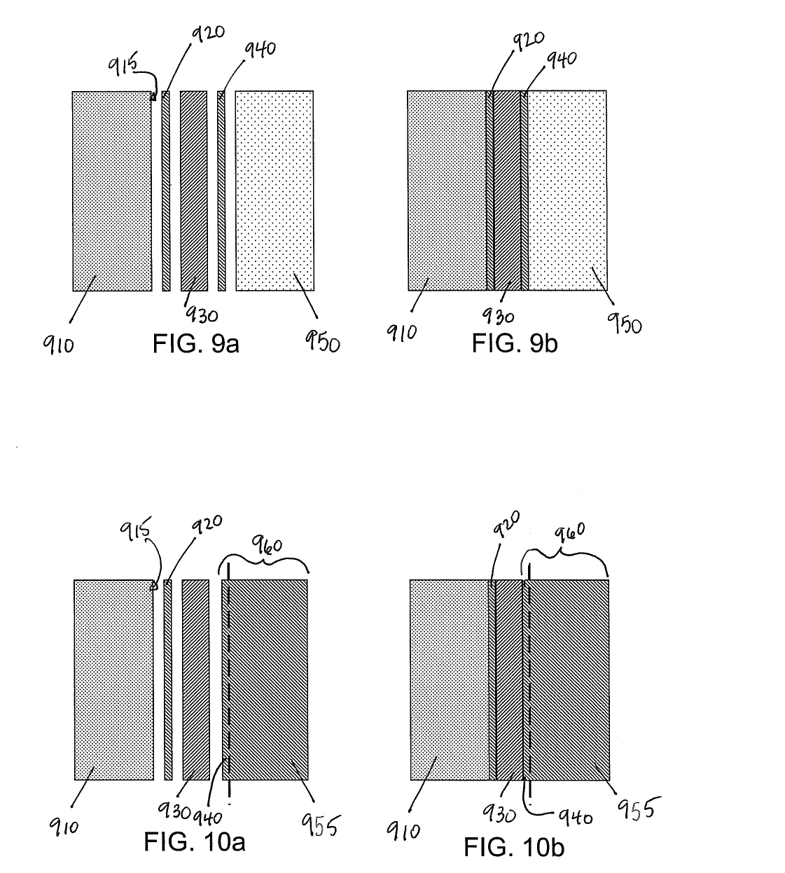

Exemplary embodiments are shown in FIGS. 9a, 9b and 10a, 10b. FIGS. 9a and 10a show “exploded” views of the material arrangements; FIGS. 9b and 10b show views of the materials when they are in contact with one another. In one embodiment of the invention, a method for bonding components includes providing at least three metal layers adjacent a bonding surface 915 on a first component 910. There is a first metal layer 920 in contact with the bonding surface 915, a core metal layer 930 in contact with the first metal layer 920 and a second metal layer 940 in contact with the core metal layer 930. The core metal layer 930 can be a brazing alloy as discussed above.

There is a second component 950, 955 to be bonded to the first component 910. In the arrangement shown in FIGS. 9a, 9b, the second component 950 is made of a material different from the second metal layer 940. In the arrangement shown in FIGS. 10a, 10b, the second component 955 is made of the same material (metal) as the second metal layer 940 and component 955 and layer 940 constitute one piece 960—they form a monolithic whole 960. One can say that the surface region 940 of the piece 960 participates in the bonding of component region 955 with component 910.

The metal layers are heated to a temperature sufficient to transform at least a portion of the metal layers into a liquid. The treatment temperature is below the melting point of the core metal layer 930 or the brazing alloy. The treatment temperature is maintained until the liquid begins to form a solidifying interlayer between the components 910 and 950 or 910 and 955 and/or the first points of bonding or solidification between the components 910, 950 or 955, and the solidifying interlayer are established.

In one arrangement, the first component 910 and the second component 950 are both ceramic. In another arrangement, the first component 910 is ceramic and the second component 950 or 955 is metal. In one arrangement, the first metal layer 920 and the second metal layer 940 are the same material. In another arrangement, the first metal layer 920 and the second metal layer 940 are different materials. In one arrangement, the first metal layer 920 and/or the second metal layer 940 includes indium at least in part.

Examples of appropriate brazing alloys for the core layer 930 include Incusil-ABA™, Cusil-ABA™, Ticusil-ABA™, Silver-ABA™, and Copper-ABA™. In one arrangement, the core metal layer 930 has a thickness between about 5 μm and 500 μm. In another arrangement, the core metal layer 930 has a thickness between about 25 μm and 500 μm. In another arrangement, the core metal layer 930a thickness between about 25 μm and 100 μm. In one arrangement, the ratio of thicknesses between the core metal layer 930 and either the first 920 or the second metal layer 940 is between about 0.001 and 0.2.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself. Specifically, modification of the Ti content in reactive metal brazes can alter and improve the joint properties, as has been demonstrated by using a higher Ti content Ticusil-ABA™ core layer foil.

I claim:

1. A method for bonding components, comprising:
(a) providing a first component;
(b) providing at least three metal layers:
a first metal layer comprising a first metal adjacent the first component;
a core metal layer comprising a brazing alloy adjacent the first metal layer; and
a second metal layer comprising a second metal adjacent the core layer;
(c) providing a second component adjacent the second metal layer;
(d) heating the metal layers to a treatment temperature sufficient to transform at least part of the metal layers into a liquid, the treatment temperature below a melting point of the brazing alloy; and
(d) maintaining the treatment temperature until the liquid begins to form a solidifying interlayer between the first and second components and the first points of bonding between the components and the solidifying interlayer are established.

2. The method of claim 1 wherein the second component comprises a metal, and the second component and second metal layer comprise a monolithic whole.

3. The method of claim 1 wherein the first and second components comprise a ceramic material.

4. The method of claim 1 wherein the brazing alloy is selected from the group consisting of Incusil-ABA™, Cusil-ABA™, Ticusil-ABA™, Silver-ABA™, and Copper-ABA™.

5. The method of claim 1 wherein the first metal layer and the second metal layer each comprises indium.

6. The method of claim 1 wherein the core metal layer has a thickness between about 5 μm and 500 μm.

7. The method of claim 1 wherein the core metal layer has a thickness between about 25 μm and 500 μm.

8. The method of claim 1 wherein the core metal layer has a thickness between about 25 μm and 100 μm.

9. The method of claim 1 wherein a ratio of thicknesses between the core metal layer and either the first or the second metal layer is between about 0.001 and 0.2.

10. A method for bonding components, comprising:
(a) providing a first component comprising ceramic;
(b) providing a second component adjacent the first component, the second component comprising metal;
(c) placing at least two metal layers between the first and second components, a first layer comprising a first metal adjacent the first component, and a core layer comprising a brazing alloy adjacent the second component, thus forming an assembly;
(d) heating the assembly to a treatment temperature sufficient to transform at least part of the assembly into a liquid, the treatment temperature below the brazing alloy melting point; and
(e) maintaining the assembly at the treatment temperature until the liquid begins to form a solidifying interlayer between the first and second components and the first points of contact between the components and the solidifying interlayer are established.
